(19) United States
(12) Patent Application Publication
(10) Pub. No.: US 2014/0179311 A1
(43) Pub. Date: Jun. 26, 2014

(54) Cell Search Method and System and Terminal Device

(71) Applicant: Huawei Technologies Co., Ltd., (unknown)

(72) Inventors: Guipeng Liang, Beijing (CN); Heya Na, Shenzhen (CN)

(21) Appl. No.: 14/044,591

(22) Filed: Oct. 2, 2013

(30) Foreign Application Priority Data
Dec. 24, 2012 (CN) 201210566581.6

(51) Int. Cl. H04W 48/16

(52) U.S. Cl. CPC H04W 48/16
USPC 455/434

(57) ABSTRACT

Embodiments of the present invention provide a cell search method and a system, and a terminal device. The cell search method includes selecting at least two antennas and each cell searcher corresponding to each antenna, configuring cell search parameters for each cell searcher, where the cell search parameters include a communications standard, a band, and a frequency corresponding to a cell to be searched, and controlling each cell searcher to search for the cell according to the cell search parameters.

### CROSS-REFERENCE TO RELATED APPLICATIONS

This application claims priority to Chinese Patent Application No. 201210566581.6, filed on Dec. 24, 2012, which is hereby incorporated by reference in its entirety.

### TECHNICAL FIELD

The present invention relates to the field of communications technologies, and in particular, to a cell search method and a system, and a terminal device.

### BACKGROUND

Since foundation of different standardization organizations such as the 3GPP (The 3rd Generation Partnership Project, the 3^{rd} Generation Partnership Project) and the 3GPP2 (3rd Generation Partnership Project 2, the 3^{rd} Generation Partnership Project 2), multiple communications technology standards have been researched and developed, including radio communications technology standards such as GSM (global system for mobile communications, Global System for Mobile communications), CDMA (Code Division Multiple Access, Code Division Multiple Access), and LTE (Long Term Evolution, Long Term Evolution). These different communications technologies define specific operating bands and frequency ranges. The GSM communications technology standard is used as an example. The GSM communications standard defines up to 14 bands, including a 900 MHz band and an 1800 MHz band applied to GSM networks of China and Europe, and a 1900 MHZ band applied to American GSM. The development of multiple communications standards and multiple-band technologies gives rise to multi-mode terminals and multi-band terminals that support multiple communications standards and multiple bands.

Multi-mode terminals and multi-band terminals support multiple communications standards or multiple bands. Such terminals perform cell search operations when accessing a cell. Specifically, according to the supported bands and user-predefined information, a terminal searches for cells corresponding to the supported multiple bands to find and access a cell corresponding to the most suitable communications standard or operating band. Currently, when a terminal supporting multiple communications standards or multiple bands searches for a cell, one antenna and a corresponding cell searcher are generally used to search for the cell. In a preset order, the cell searcher consecutively traverses communications standards, bands, and frequencies supported by the terminal to search for the cell. Such a cell search manner takes much time for searching for a suitable access cell, which leads to low search efficiency.

### SUMMARY

In view of that, embodiments of the present invention provide a cell search method and a system, and a terminal device to solve the low efficiency caused by much time spent on the existing cell search manner of searching for a suitable access cell.

In a first aspect, a method for implementing cell search is provided, including:

selecting at least two antennas and each cell searcher corresponding to each antenna; configuring cell search parameters for each cell searcher, where the cell search parameters include a communications standard, a band, and a frequency corresponding to a cell to be searched by each cell searcher; and controlling each cell searcher to search for the cell according to the cell search parameters.

In a first possible implementation manner, the cell search parameters of the cell searchers have the same communications standard, the same band, and different frequencies; and the controlling each cell searcher to search for the cell according to the cell search parameters includes: controlling each cell searcher to search for the cell on respective frequencies of the same band in the same communications standard.

In a first possible implementation manner, the cell search parameters of the cell searchers have the same communications standard, and different bands and frequencies; and the controlling each cell searcher to search for the cell according to the cell search parameters includes: controlling each cell searcher to search for the cell on respective frequencies of respective bands in the same communications standard.

In a first possible implementation manner, the cell search parameters of the cell searchers have different communications standards, bands, and frequencies; and the controlling each cell searcher to search for the cell according to the cell search parameters includes: controlling each cell searcher to search for the cell on respective frequencies of respective bands in respective communications standards, where one cell searcher performs cell search on one frequency.

In a first possible implementation manner, the at least two antennas selected are all or part of antennas of a multi-antenna terminal

In a first possible implementation manner, the method further includes:

determining whether a cell meeting cell access conditions exists in cells searched by all the cell searchers; and, if a cell meeting the cell access conditions exists, accessing the cell meeting the cell access conditions.

the determining whether a cell meeting cell access conditions exists in the cells searched by all the cell searchers includes: according to a priority of each cell communications feature, sorting the cells searched by all the cell searchers; determining whether cell communications features corresponding to a highest-priority cell are consistent with cell communications features required by the cell access conditions; and if the cell communications features corresponding to the highest-priority cell are consistent with the cell communications features required by the cell access conditions, determining that the highest-priority cell is the cell meeting cell access conditions.

In another aspect, a cell search system is provided, including:

a selecting module, configured to select at least two antennas and each cell searcher corresponding to each antenna, where the at least two antennas and each cell searcher corresponding to each antenna is located in a terminal device; a configuring module, adapted to configure cell search parameters for each cell searcher, where the cell search parameters include a communications standard, a band, and a frequency corresponding to a cell to be searched by each cell searcher; and a controlling module, configured to control each cell searcher to search for the cell according to the cell search parameters.

In a first possible implementation manner, the cell search parameters configured by the configuring module for the cell searchers have the same communications standard, the same band, and different frequencies; or, the cell search parameters configured for the cell searchers have the same communications standard, different bands and frequencies; or, the cell search parameters configured for the cell searchers have different communications standards, bands, and frequencies.

In another aspect, a terminal device is provided, including: multiple antennas, cell searchers whose quantity is the same as the quantity of the multiple antennas, and a controller, where: the controller is connected with the cell searchers; the controller is configured to select at least two antennas and each cell searcher corresponding to each antenna, configure cell search parameters for each cell searcher, and control each cell searcher to search for the cell according to the cell search parameters, where the cell search parameters include a communications standard, a band, and a frequency corresponding to a cell to be searched; and the cell searcher is configured to search for the cell according to the cell search parameters configured by the controller.

In a possible implementation manner, the terminal device further includes: an access cell determining module, configured to determine whether a cell meeting cell access conditions exists in cells searched by all the cell searchers; and, if a cell meeting the cell access conditions exists, access the cell meeting the cell access conditions.

In a possible implementation manner, the access cell determining module includes: a sorting unit, configured to: according to priorities of different cell communications features, sort the cells searched by all the cell searchers; a judging unit, configured to determine whether cell communications features corresponding to a highest-priority cell are consistent with cell communications features required by the cell access conditions; and a determining unit, configured to: if a determination result of the judging unit is affirmative, determine that the highest-priority cell is the cell meeting the cell access conditions.

In another aspect, a terminal device is provided, including: multiple antennas, cell searchers whose quantity is the same as the quantity of the multiple antennas, a controller, and a processor; where: the controller is connected with the cell searchers; the cell searchers are connected with the processor; the controller is configured to select at least two antennas and each cell searcher corresponding to each antenna, configure cell search parameters for each cell searcher, and control each cell searcher to search for the cell according to the cell search parameters, where the cell search parameters include a communications standard, a band, and a frequency corresponding to a cell to be searched; the cell searcher is configured to search for the cell according to the cell search parameters configured by the controller; and the processor is configured to determine whether a cell meeting cell access conditions exists in the cells searched by all the cell searchers; and, if a cell meeting the cell access conditions exists, access the cell meeting the cell access conditions.

Based on the foregoing technical solutions, in the cell search method provided in the embodiments of the present invention, at least two antennas and a cell searcher corresponding to each antenna are selected, one antenna corresponds to one cell searcher, different cell search parameters are configured for each cell searcher, and each cell searcher is controlled to search for the cell according to the configured cell search parameters, thereby fulfilling the purpose of multiple cell searchers searching for cells simultaneously, implementing concurrent cell search, improving the cell search efficiency, and solving the low efficiency problem caused by much time spent on the existing serial cell search manner of searching for a suitable access cell.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a cell search method according to an embodiment of the present invention;

FIG. 2 is a schematic diagram of a relationship between an antenna and a cell searcher in a multi-antenna terminal according to an embodiment of the present invention;

FIG. 3 is a flowchart of another cell search method according to an embodiment of the present invention;

FIG. 4 is a flowchart of determining existence of a cell meeting cell access conditions according to an embodiment of the present invention;

FIG. 5 is a schematic structural diagram of a cell search system according to an embodiment of the present invention;

FIG. 6 is a structural block diagram of a terminal device according to an embodiment of the present invention;

FIG. 7 is a schematic structural diagram of another terminal device according to an embodiment of the present invention;

FIG. 8 is a schematic structural diagram of an access cell determining module according to an embodiment of the present invention;

FIG. 9 is another structural block diagram of a terminal device according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

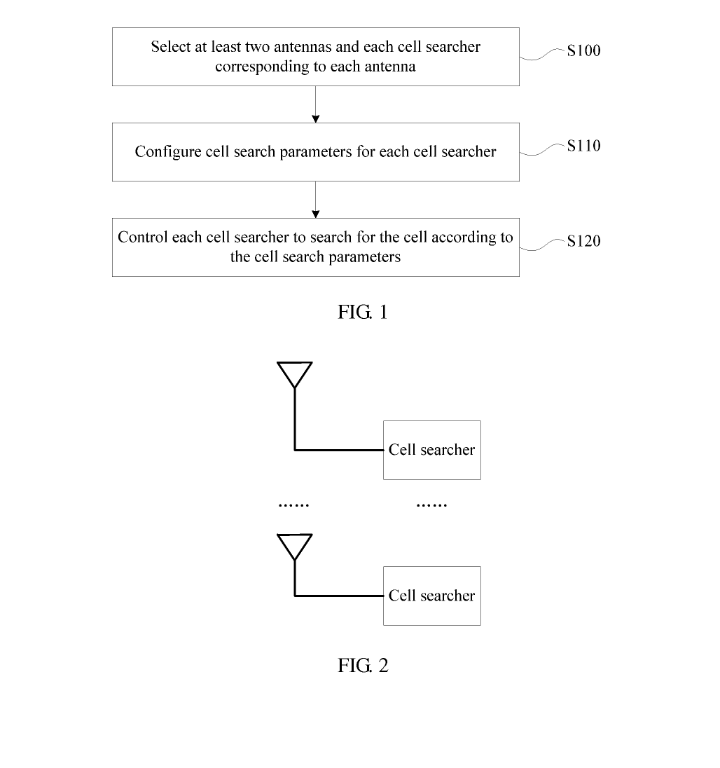

FIG. 1 is a flowchart of a cell search method according to an embodiment of the present invention. As shown in FIG. 1, the method may include the following steps:

Step S100: Select at least two antennas and each cell searcher corresponding to each antenna.

The cell search method provided in the embodiment of the present invention is based on a multi-antenna terminal, and each antenna in the multi-antenna terminal corresponds to a unique cell searcher, that is, one antenna corresponds to one cell searcher.

FIG. 2 shows a relationship between an antenna and a cell searcher in the multi-antenna terminal, which may serve as a reference.

Step S110: Configure cell search parameters for each cell searcher.

The cell search parameters may include a communications standard, a band, and a frequency corresponding to a cell to be searched. In the embodiment of the present invention, the cell search parameters configured for each cell searcher are different from each other. That is, in the cell search parameters configured for any two cell searchers, at least one of the communications standard, the band, and the frequency is different.

Optionally, the cell search parameters configured for each cell searcher may have the same communications standard, the same band, and different frequencies, that is, in the cell search parameters configured for any two cell searchers, the communications standard and the band information are necessarily the same, but the frequency information is different. For better description, assuming that three cell searchers are selected (that is, the quantity of selected antennas is 3), the cell search parameters may be specifically configured as follows:

Cell searcher 1: LTE standard, band 3, and frequency 1;

Cell searcher 2: LTE standard, band 3, and frequency 2; and

Cell searcher 3: LTE standard, band 3, and frequency 3.

Optionally, the cell search parameters configured for each cell searcher may have the same communications standard, and different bands and frequencies, that is, in the cell search parameters configured for any two cell searchers, the communications standard information is necessarily the same, but the band and frequency information is necessarily different. For better description, assuming that three cell searchers are selected (that is, the quantity of selected antennas is 3), the cell search parameters may be specifically configured as follows:

Cell searcher 1: LTE standard, band 3, and frequency 1;

Cell searcher 2: LTE standard, band 7, and frequency 2; and

Cell searcher 3: LTE standard, band 20, and frequency 3.

Optionally, the cell search parameters configured for each cell searcher may have different communications standards, bands, and frequencies, that is, in the cell search parameters configured for any two cell searchers, the communications standard information, and the band and frequency information are different. For better description, assuming that three cell searchers are selected (that is, the quantity of selected antennas is 3), the cell search parameters may be specifically configured as follows:

Cell searcher 1: LTE standard, band 3, and frequency 1;

Cell searcher 2: UMTS (Universal Mobile Telecommunication System, Universal Mobile Telecommunication System) standard, band 1, and frequency 2; and

Cell searcher 3: GSM standard, band 8, and frequency 3.

The cell search parameter configuration manners enumerated above are optional. Obviously, in the embodiment of the present invention, the cell search parameters may also be configured for each cell searcher in other manners. For example, in the cell search parameters configured for the cell searchers, a part of the cell searchers may have the same communications standard, the same band and different frequency, and another part of the cell searchers may have the same communications standard, and different bands and frequencies. In the embodiment of the present invention, any configuration manner is appropriate as long as configured cell search parameters vary according to cell searchers and no duplicate cell search parameters exist, where the duplicate cell search parameters lead to duplicate cell search subsequently.

Optionally, the cell search parameters configured for each cell searcher may be predefined. After the cell searchers are selected, the predefined cell search parameters are directly loaded onto each cell searcher in a preset order. Obviously, the cell search parameters may also be defined after the cell searchers are selected, that is, defined on site, where the cell search parameters corresponding to each cell searcher are defined after the cell searchers are selected.

Optionally, the cell search parameters configured for each cell searcher may be automatically configured as parameters corresponding to a cell that is accessed frequently by the multi-antenna terminal. In the embodiment of the present invention, the cell search parameters may be predefined or defined on site at the user's discretion, or may be preset in the multi-antenna terminal by an operator.

It should be noted that the communications standards mentioned in the embodiment of the present invention refers to not only communications standards of a cellular mobile telecommunications system, such as GSM and LTE, but also WIFI, WIMAX, and other communications standards. The communications standard mentioned in the embodiment of the present invention may be any communications technology that falls within the radio communications field and uses a cell to accommodate end users.

Step S120: Control each cell searcher to search for the cell according to the cell search parameters.

After the cell search parameters are configured for each cell searcher, each cell searcher may be controlled to search for the cell corresponding to the cell search parameters to obtain a cell search result.

Optionally, if the configured cell search parameters have the same communications standard, the same band, and different frequencies, each cell searcher may be controlled to perform cell search on respective frequencies of the same band in the same communications standard.

Optionally, if the configured cell search parameters have the same communications standard, and different bands and frequencies, each cell searcher may be controlled to perform cell search on respective frequencies of respective bands in the same communications standard.

Optionally, if the configured cell search parameters have different communications standards, bands, and frequencies, each cell searcher may be controlled to perform cell search on respective frequencies of respective bands in respective communications standards.

In the embodiment of the present invention, when a cell search is performed, each cell searcher performs the cell search on only one frequency, and frequencies searched by cell searchers vary. Such settings can ensure implementation of concurrent cell search without duplicate cell search according to the embodiment of the present invention.

Compared with a single antenna and the serial cell search manner implemented by a corresponding cell searcher in the prior art, the cell search method provided in the embodiment of the present invention selects at least two antennas and a cell searcher corresponding to each antenna, one antenna corresponds to one cell searcher, different cell search parameters are configured for each cell searcher, and each cell searcher is controlled to search for the cell according to the configured cell search parameters, thereby fulfilling the purpose of multiple cell searchers searching for cells simultaneously, implementing concurrent cell search, improving the cell search efficiency, and solving the low efficiency caused by much time spent on the existing serial cell search manner of searching a suitable access cell.

Optionally, the at least two antennas selected in the embodiment of the present invention may be all antennas of a multi-antenna terminal, or a part of antennas in many antennas of the multi-antenna terminal, which may be specifically set according to actual application conditions and is not limited herein.

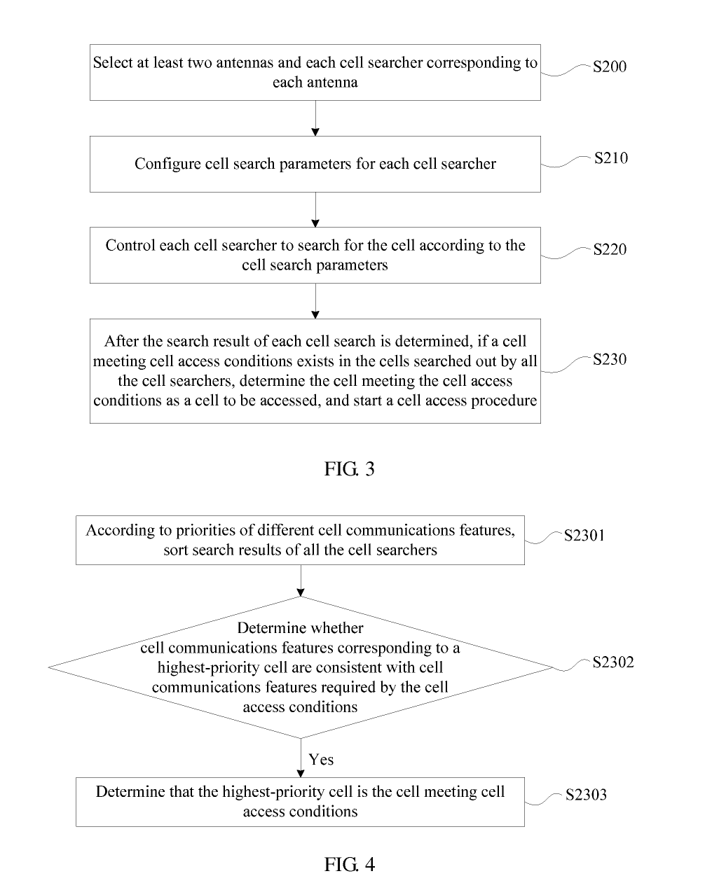

FIG. 3 is a flowchart of another cell search method according to an embodiment of the present invention. As shown in FIG. 3, the method may include the following steps:

Step S200. Select at least two antennas and each cell searcher corresponding to each antenna.

Step S210: Configure cell search parameters for each cell searcher.

The cell search parameters may include a communications standard, a band, and a frequency corresponding to a cell to be searched.

Step S220: Control each cell searcher to search for the cell according to the cell search parameters.

Evidently, steps S200, S210, and S220 are similar to steps S100, S110, and S120 shown in FIG. 1, and mutual reference may be made to the cell search method described earlier above.

Step S230: After the search result of each cell search is determined, if a cell meeting cell access conditions exists in the cells searched by all the cell searchers, determine the cell meeting the cell access conditions as a cell to be accessed, and start a cell access procedure.

The cell access conditions refer to defined requirements imposed by the multi-antenna terminal on the cell to be accessed, including communications features of the cell. The cell to be accessed refers to a determined cell to be accessed by the multi-antenna terminal.

Specifically, as shown in FIG. 4, the process of determining whether a cell meeting cell access conditions exists in the cells searched by all the cell searchers includes the following steps:

Step S2301: Sort search results of all the cell searchers according to priorities of different cell communications features.

The cell communications features may be parameters that reflect cell communications features such as signal strength of a cell, quantity of terminals accommodated by a cell, and a congestion degree of a cell. The cell communications features mentioned in the embodiment of the present invention may be any cell communications parameters that a terminal cares when accessing a cell. For different cell communications features, priority-based sorting of search results of cell searchers is different. For example, a high-priority cell in the result of sorting that uses high signal strength as a priority does not necessarily have a high priority in the result of sorting that uses a low congestion degree of a cell as a priority. Therefore, after the search results of all cell searchers are sorted according to the priorities of different cell communications features, multiple priority sorting results of different cell communications features may be obtained.

Step S2302: Determine whether cell communications features corresponding to a highest-priority cell in the cell communications features corresponding to the cell access conditions are consistent with cell communications features required by the cell access conditions.

The cell access conditions may be a cell communications feature. For example, the cell access conditions may be high signal strength or a low congestion degree of the cell being used as an access cell. Therefore, after the search results are sorted according to the priorities of different cell communications features, the cell communications feature corresponding to the highest-priority cell may be obtained in the cell communications features corresponding to the cell access conditions, and a determination is made about whether the cell communications feature is consistent with the cell communications feature required by the cell access conditions. For ease of understanding, a congestion degree of a cell less than 50% is used as a cell access condition and a low congestion degree is used as a high priority in a sorting result, a cell of the highest priority is obtained, and a determination is made about whether the congestion degree of the highest-priority cell is consistent with the cell congestion degree required by the cell access condition.

Step S2303: If yes, determine that the highest-priority cell is the cell meeting cell access conditions.

Obviously, the process of determining whether a cell meeting cell access conditions exists in the cells searched by all the cell searchers may also be: sorting the search results of all the cell searchers according to the priorities of the cell communications features corresponding to the cell access conditions, and determining whether the cell communications features corresponding to the highest-priority cell are consistent with the cell communications features required by the cell access conditions; and, if yes, determining that the highest-priority cell is the cell meeting the cell access conditions.

Optionally, if no cell search result meeting the cell communications features required by the cell access conditions exists, the embodiment of the present invention may reconfigure different cell search parameters for each cell searcher, and perform cell search and access again. The reconfigured cell search parameters may be predefined or defined on site.

In the cell access method provided in the embodiment of the present invention, the purpose of using multiple cell searchers to search for cells simultaneously is implemented in a parallel cell search manner, and the cell search efficiency is improved. In addition, the first cell suitable for access, which is searched in a serial cell search manner in the prior art, is not necessarily a cell that is most suitable for access among current available cells of all access standards/bands, which will trigger a terminal to reselect the cell after accessing and lead to terminal power consumption and time loss. In the embodiment of the present invention, however, multiple cells are searched simultaneously, the probability of searching the most suitable cell by a multi-antenna terminal at a single attempt is increased, the probability of initiating cell reselection by the terminal after the access is reduced, and the terminal power consumption and the access time are reduced.

The following describes a cell search system according to an embodiment of the present invention. The system described below corresponds to the cell search method shown in FIG. 1, and mutual reference may be made between them.

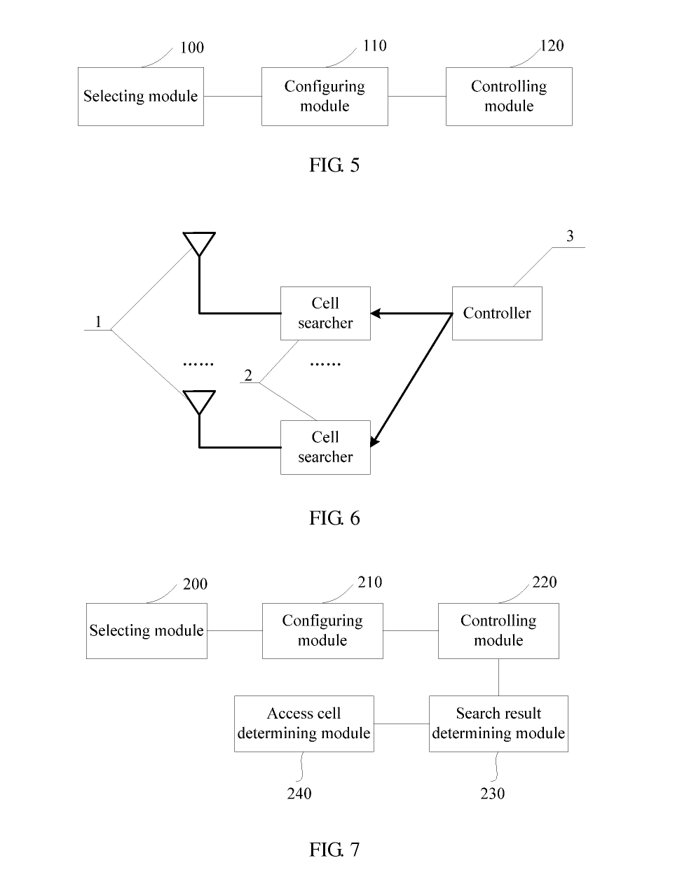

FIG. 5 is a schematic structural diagram of a cell search system according to an embodiment of the present invention. The system may be set in a multi-antenna terminal. As shown in FIG. 5, the system may include:

a selecting module 100, configured to select at least two antennas and each cell searcher corresponding to each antenna,

where one antenna corresponds to one cell searcher, and the at least two antennas and each cell searcher corresponding to each antenna is located in the terminal device;

a configuring module 110, adapted to configure cell search parameters for each cell searcher, where the cell search parameters may include a communications standard, a band, and a frequency corresponding to a cell to be searched; and

a controlling module 120, configured to control each cell searcher to search for the cell according to the cell search parameters.

The cell search parameters configured by the configuring module 110 for the cell searchers may have the same communications standard, the same band, and different frequencies; or have the same communications standard, and different bands and frequencies;

or have different communications standards, bands, and frequencies. Obviously, it is appropriate as long as the cell search parameters configured by the configuring module 100 vary according to cell searchers.

FIG. 6 shows a structure of a terminal device. The terminal device of the structure corresponds to the cell search method shown in FIG. 1, and mutual reference may be made between them. As shown in FIG. 6, the terminal device is a multi-antenna terminal, including: multiple antennas 1, cell searchers 2 whose quantity is the same as the quantity of the multiple antennas 1, and a controller 3, where one antenna corresponds to one cell searcher and the controller 3 is connected with the cell searchers.

The controller 3 is configured to select at least two antennas and each cell searcher corresponding to each antenna, configure cell search parameters for each cell searcher, and control each cell searcher to search for the cell according to the cell search parameters, where the cell search parameters include: a communications standard, a band, and a frequency corresponding to a cell to be searched.

The cell searcher 2 is configured to search for the cell according to the cell search parameters configured by the controller 3.

Optionally, the controller 3 may select a cell searcher through an interface connected with each cell searcher 2, configure the cell search parameters, and control cell search.

The following describes a cell access system according to an embodiment of the present invention. The cell access system described below corresponds to the cell access method described above, and mutual reference may be made between them.

FIG. 7 is a schematic structural diagram of another terminal device according to an embodiment of the present invention. As shown in FIG. 7, the terminal device may include:

a selecting module 200, configured to select at least two antennas and each cell searcher corresponding to each antenna, where one antenna corresponds to one cell searcher, and the at least two antennas and the cell searcher corresponding to each antenna is located in the terminal device; a configuring module 210, adapted to configure cell search parameters for each cell searcher, where the cell search parameters include a communications standard, a band, and a frequency corresponding to a cell to be searched; and a controlling module 220, configured to control each cell searcher to search for the cell according to the cell search parameters;

a search result determining module 230, configured to determine a search result of each cell searcher after each cell searcher performs the cell search; and

an access cell determining module 240, configured to determine whether a cell meeting cell access conditions exists in the cells searched by all the cell searchers; and, if yes, determine that the cell meeting the cell access conditions is a cell to be accessed, and start a cell access procedure.

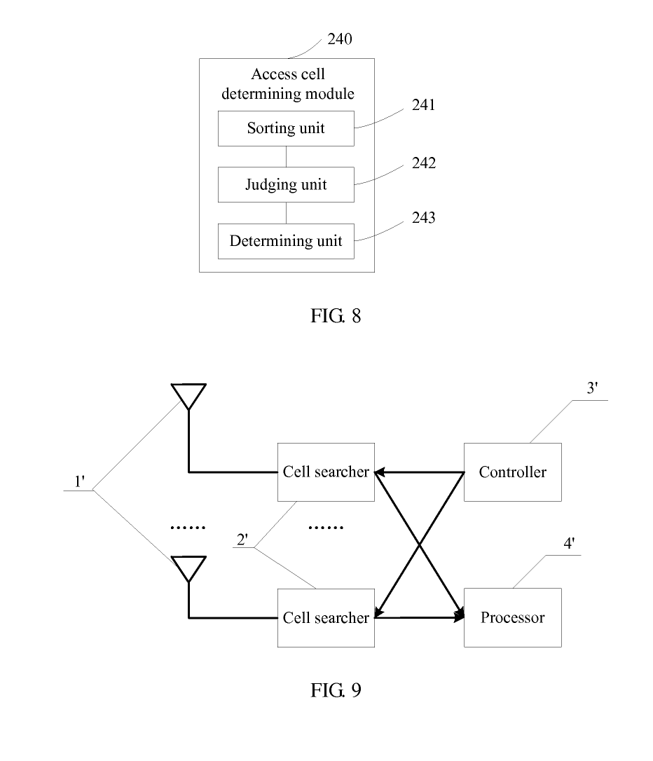

FIG. 8 shows a structural block diagram of an access cell determining module 240. As shown in FIG. 8, the access cell determining module 240 may include:

a sorting unit 241, configured to: according to priorities of different cell communications features, sort cells searched by all cell searchers; a judging unit 242, configured to determine whether cell communications features corresponding to a highest-priority cell in cell communications features corresponding to cell access conditions are consistent with cell communications features required by the cell access conditions; and a determining unit 243, configured to: if a determination result of the judging unit is affirmative, determine that the highest-priority cell is the cell meeting the cell access conditions.

It should be noted that FIG. 8 shows merely an optional structure of an access cell determining module 240.

FIG. 9 shows a structure of a terminal device. The terminal device of the structure corresponds to the cell access method shown in FIG. 3, and mutual reference may be made between them. As shown in FIG. 9, the terminal device is a multi-antenna terminal, including: multiple antennas 1′, cell searchers 2′ whose quantity is the same as the quantity of the multiple antennas 1′, a controller 3′, and a processor 4′, where one antenna corresponds to one cell searcher, the controller 3′ is connected with each cell searcher, and each cell searcher is connected with the processor 4′.

The controller 3′ is configured to select at least two antennas and the cell searcher corresponding to each antenna, configure different cell search parameters for each cell searcher, and control each cell searcher to search for the cell according to the configured cell search parameters.

The cell search parameters include a communications standard, a band, and a frequency corresponding to a cell to be searched.

The cell searcher 2′ is configured to search for the cell according to the cell search parameters configured by the controller 3′.

The processor 4′ is configured to determine whether a cell meeting cell access conditions exists in the cells searched by all the cell searchers; and, if a cell meeting the cell access conditions exists, access the cell meeting the cell access conditions.

Optionally, the controller 3′ may select a cell searcher through an interface connected with each cell searcher 2′, configure the cell search parameters, and control cell search.

The processor 4′ may receive search results through the interface connected with each cell searcher 2′, determine the cell to be accessed, and start a cell access procedure, where the search results are sent by each cell searcher after the cell search.

The cell access procedure is the same as that in the prior art, and is not repeated here any further.

The cell search and access method, system and terminal device provided in the embodiments of the present invention fulfill the purpose of multiple cell searchers performing cell search simultaneously, implement concurrent cell search, and improve the cell search efficiency; and increase the probability of searching out the most suitable cell by a multi-antenna terminal at a single attempt, reduce the probability of initiating cell reselection by the terminal after the access, and reduce terminal power consumption and access time.

The embodiments herein are all described in a progressive manner, mutual reference may be made to the same or similar part of the embodiments, and each embodiment focuses on differences from other embodiments. As regards the apparatus disclosed in the embodiments, since the apparatus corresponds to the method disclosed in the embodiments, the apparatus is described briefly, and reference may be made to the corresponding part of the description of the method for the related part of the apparatus.

Those skilled in the art will further appreciate that the various units and algorithm steps described in connection with the embodiments disclosed herein can be implemented as electronic hardware, computer software, or a combination of both. To describe the interchangeability of hardware and software, various illustrative components and steps have been described above generally in terms of their functionality. Whether the functions are performed by hardware or software depends on particular applications and design constraint conditions of the technical solutions. Persons skilled in the art may use different methods to implement the described functions for each particular application, but it should not be considered that the implementation goes beyond the scope of the present invention.

The steps of a method or algorithm described in connection with the embodiments disclosed herein can be embodied directly in hardware, in a software module executed by a processor, or in a combination of the two. A software module can reside in a random access memory (RAM), flash memory, read-only memory (ROM), electrically programmable ROM (EPROM), electrically erasable programmable ROM (EEPROM), register, hard disk, removable disk, CD-ROM, or any other form of storage medium known in the art.

The foregoing descriptions about the disclosed embodiments enable those skilled in the art to implement or use the embodiments of the invention. Various modifications of the embodiments are apparent to those skilled in the art, and general principles defined herein can be implemented in other embodiments without departing from the spirit or scope of the invention. Therefore, the invention is not limited to the exemplary embodiments given herein, but meets the widest scope that matches the principles and novelty disclosed herein.

1-13. (canceled)

14. A cell search method, comprising:
selecting at least two antennas, and respective cell searchers, wherein each cell searcher corresponds to a respective antenna;
configuring cell search parameters for the each cell searcher, wherein the cell search parameters comprise a communications standard, a band, and a frequency corresponding to a cell to be searched by the each cell searcher; and
controlling the each cell searcher to search for the cell according to the cell search parameters.

15. The method according to claim 14, wherein the cell search parameters of all cell searchers have a same communications standard, a same band, and different frequencies; and
the controlling the each cell searcher to search for the cell according to the cell search parameters comprises controlling the each cell searcher to search for the cell on respective frequencies of the same band in the same communications standard.

16. The method according to claim 14, wherein the cell search parameters of all cell searchers have a same communications standard, and different bands and frequencies; and
the controlling the each cell searcher to search for the cell according to the cell search parameters comprises controlling the each cell searcher to search for the cell on respective frequencies of respective bands in the same communications standard.

17. The method according to claim 14, wherein the cell search parameters of all cell searchers have different communications standards, and different bands and frequencies; and
the controlling the each cell searcher to search for the cell according to the cell search parameters comprises controlling the each cell searcher to search for the cell on respective frequencies of respective bands in respective communications standards, wherein one cell searcher searches for the cell on one frequency.

18. The method according to claim 14, wherein the at least two antennas selected are all or part of antennas of a multi-antenna terminal.

19. The method according to claim 14, further comprising:
determining whether a cell meeting cell access conditions exists in cells searched by all the cell searchers; and
when a cell meeting the cell access conditions exists, accessing the cell meeting the cell access conditions.

20. The method according to claim 19, wherein the determining whether a cell meeting cell access conditions exists in the cells searched by all the cell searchers comprises:
according to a priority of each cell communications feature, sorting the cells searched by all the cell searchers;
determining whether cell communications features corresponding to a highest-priority cell are consistent with cell communications features required by the cell access conditions; and
when the cell communications features corresponding to the highest-priority cell are consistent with the cell communications features required by the cell access conditions, determining that the highest-priority cell is the cell meeting cell access conditions.

21. A cell search system, comprising:
a selecting module, configured to select at least two antennas, and respective cell searchers, wherein each cell searcher corresponds to a respective antenna, wherein the at least two antennas and the respective cell searchers are located in a terminal device;
a configuring module, adapted to configure cell search parameters for the each cell searcher, wherein the cell search parameters comprise a communications standard, a band, and a frequency corresponding to a cell to be searched by the each cell searcher; and
a controlling module, configured to control the each cell searcher to search for the cell according to the cell search parameters.

22. The system according to claim 21, wherein:
the cell search parameters configured by the configuring module for the cell searchers have a same first communications standard, a same band, and different frequencies; or, the cell search parameters configured for the cell searchers have the same communications standard, and different bands and frequencies; or, the cell search parameters configured for the cell searchers have different communications standards, bands, and frequencies.

23. A terminal device comprising:
multiple antennas;
multiple cell searchers, wherein a quantity of the cell searchers equals a quantity of the multiple antennas; and
a controller connected with the cell searchers, wherein the controller is configured to
select at least two antennas and their respective cell searchers, wherein each cell searcher of the respective cell searchers corresponds to a respective antenna of the at least two antennas,
configure cell search parameters for the each cell searcher, and
control the each cell searcher to search for the cell according to the cell search parameters, wherein the cell search parameters comprise a communications standard, a band, and a frequency corresponding to a cell to be searched; and
the cell searcher is configured to search for the cell according to the cell search parameters configured by the controller.

24. The terminal device according to claim 23, further comprising:
an access cell determining module, configured to determine whether a cell meeting cell access conditions exists in cells searched by all the cell searchers; and, when a cell meeting the cell access conditions exists, access the cell meeting the cell access conditions.

25. The terminal device according to claim 24, wherein the access cell determining module comprises:
a sorting unit, configured to, according to priorities of different cell communications features, sort the cells searched by all the cell searchers;
a judging unit, configured to determine whether cell communications features corresponding to a highest-priority cell are consistent with cell communications features required by the cell access conditions; and
a determining unit, configured to, when a determination result of the judging unit is affirmative, determine that the highest-priority cell is the cell meeting the cell access conditions.

26. A terminal device comprising:
multiple antennas;
multiple cell searchers, wherein a quantity of the cell searchers equals a quantity of the multiple antennas;
a controller connected with the cell searchers, wherein the controller is configured to
select at least two antennas and their respective cell searchers, wherein each cell searcher of the respective cell searchers corresponds to a respective antenna of the at least two antennas,
configure cell search parameters for the each cell searcher, and
control the each cell searcher to search for the cell according to the cell search parameters, wherein the cell search parameters comprise a communications standard, a band, and a frequency corresponding to a cell to be searched, and wherein the each cell searcher is configured to search for the cell according to the cell search parameters configured by the controller; and
a processor connected with the cell searchers, wherein the processor is configured to determine whether a cell meeting cell access conditions exists in the cells searched by all the respective cell searchers; and, when a cell meeting the cell access conditions exists, access the cell meeting the cell access conditions.
